(19) United States
(12) Patent Application Publication
(10) Pub. No.: US 2023/0069899 A1
(43) Pub. Date: Mar. 9, 2023

(54) METHOD FOR LIGHT PROJECTION IN THE INTERIOR OF AN AUTOMOTIVE VEHICLE AND AUTOMOTIVE PROJECTOR ASSEMBLY

(71) Applicant: VALEO VISION, Bobigny (FR)

(72) Inventors: Vincent CORBOLIOU, Bobigny (FR); Frederic GOSSELE, Bobigny (FR)

(73) Assignee: VALEO VISION, Bobigny (FR)

(21) Appl. No.: 17/799,974

(22) PCT Filed: Feb. 11, 2021
(86) PCT No.: PCT/EP2021/053329

§ 371 Date: Aug. 16, 2022

(30) Foreign Application Priority Data
Feb. 19, 2020 (FR) FR2001634
Feb. 19, 2020 (FR) FR2001635

(51) Int. Cl. G03B 29/00; G06V 40/10; G06V 20/59; G03B 21/28; B60Q 3/10

(52) U.S. Cl. CPC G03B 29/00; G06V 40/10; G06V 20/59; G03B 21/28; B60Q 3/10

(57) ABSTRACT

The invention provides a method for light projection in the interior of an automotive vehicle. The method includes sensing, by at least one sensor, the presence of an object or person in the interior of the vehicle, wherein the sensor comprises a plurality of image sensing devices. A protection zone is defined by using the data of the at least one sensor, thus obtaining a three-dimensional protection zone. A first light pattern is projected with a first pattern zone by means of a first projector associated to a first image sensing device. A second light pattern is projected with a second pattern zone by means of a second projector associated to a second image sensing device, wherein the first pattern zone and/or the second pattern zone are projected over the protection zone and wherein the light pattern forms a projected image on an interior surface of the automotive vehicle.

### CROSS-REFERENCE TO RELATED APPLICATIONS

This application is filed under 35 U.S.C. § 371 U.S. National Phase of International Application No. PCT/EP2021/053329 filed Feb. 11, 2021 (published as WO2021165138), which claims priority benefit to French Application Nos. 2001634 and 2001635 filed on Feb. 19, 2020, the disclosures of which are herein incorporated by reference in their entirety.

### TECHNICAL FIELD

This invention is related to the field of the vehicle lighting devices intended to project light inside the vehicle.

### BACKGROUND OF THE INVENTION

Current automotive vehicles provide new functionalities to the passengers on board, from information to entertainment systems. Some of these functionalities may be provided by an internal light projector, but the incorporation of such a device inside the vehicle may not be immediate.

In some cases, the presence of a passenger may involve interferences for a correct projection of light in interior surfaces of the vehicle.

### BRIEF SUMMARY OF THE INVENTION

The invention provides a solution for these problems by means of a method for light projection in the interior of an automotive vehicle, the method comprising the steps of

sensing, by at least one sensor, the presence of an object or person in the interior of the vehicle, wherein the sensor comprises a plurality of image sensing devices;

defining a protection zone by using the data of the at least one sensor, thus obtaining a three-dimensional protection zone; and

projecting a first light pattern with a first pattern zone by means of a first projector associated to a first image sensing device, wherein,

projecting a second light pattern with a second pattern zone by means of a second projector associated to a second image sensing device,

wherein the first pattern zone and/or the second pattern zone are projected over the protection zone and wherein the light pattern forms a projected image on an interior surface of the automotive vehicle.

With this method, the shape and dimensions of the projected image may be defined according to the presence and size of the object or person, to avoid the optic interference. A high quality projected image is obtained regardless the presence of an object in the light path of the first projector.

More than two projectors may be used for this purpose to ensure that this image is perfectly obtained even when the object may be in almost every location of the vehicle.

In some particular embodiments, the first and second pattern zones are projected over the protection zone.

If the whole first and second pattern zones correspond to the whole protection zone, the amount of light is optimized.

In some particular embodiments, the first pattern zone has a lower average luminous intensity than the rest of the light pattern. In some particular embodiments, the first light pattern has an average luminous intensity lower than 1 cd in the first pattern zone. In more particular embodiments, the light pattern has no luminous intensity in the first pattern zone.

This is also a way of optimizing the amount of light emitted by the light projector.

In some particular embodiments, the steps of sensing the presence of an object and defining the protection zone are carried out more than once during the projection.

If the object is a moving object or a person, it is useful to refresh the size and location of the protection zone, so that the data is updated.

In some particular embodiments, a portion of the projected image receives only the first light pattern.

In some particular embodiments, a portion of the projected image receives only the first light pattern.

The projected image is the global result that is intended to be achieved. Sometimes, the object or person may be an obstacle for one of the projectors, so there are zones which may be reached only by one of the projectors.

In some particular embodiments, a portion of the projected image receives a combination of the first light pattern and the second light pattern.

In other situations, there are zones of the projected image which are reached by both projectors. In these zones, the luminous intensity of a particular zone is shared by the projection of the two light projectors, so the luminous intensity of each one should be carefully chosen to obtain a total result which is according to the desired pattern.

In a second inventive aspect, the invention provides an automotive projection assembly comprising

at least a first image sensing device;

a first light projector associated to the first image sensing device;

a second image sensing device;

a second light projector associated to the second image sensing device; and

a projector control unit configured to carry out the steps of a method according to the first inventive aspect.

Such an automotive projection assembly is useful to obtain a projected image without being affected and without affecting objects or people that may be present in the vehicle.

In some particular embodiments, the projector control unit is also configured to perform a positional calibration of the first light projector with respect to the second light projector.

When more than one light projector is present, a calibration device is useful to keep both light projectors coordinated.

In some particular embodiments, the first and second light projectors are configured to project a three-dimensional light pattern.

In some particular embodiments, the automotive projection assembly further comprises a mirror, wherein the first or the second light projector is configured to project a light pattern towards the mirror.

A mirror may improve the ability of the projectors to reach the projection zone avoiding the presence of any object. Since the mirror may be smaller than the projector, it may be placed in almost every location of the vehicle.

In some particular embodiments, the mirror comprises a rotatory element configured to rotate the mirror. In some particular embodiments, the rotatory element comprises attaching means for attaching the rotatory element to a roof of an automotive vehicle.

This rotatory element is used for a better customization of the direction of the light pattern. Its position in the roof of a vehicle is particularly advantageous, since it does not disturb the rest of the passengers.

In some particular embodiments, the automotive projection assembly further comprises attaching means for attaching the first and/or second light projector to a roof of a vehicle.

In some particular embodiments, the rotatory element is configured to provide rotation in two different axis.

In some particular embodiments, the automotive projection assembly further comprises a housing where the light projector and the mirror are housed.

In some particular embodiments, the distance between the light projector and the mirror is lower than 40 cm.

In some particular embodiments, the automotive projection assembly further comprises a communication port, configured to send and/or receive information via a communication protocol, such as WPAN, WLAN, WMAN or WWAN.

Such a communication port, which may be comprised in the light projector or outside it (e.g., associated to the communication port of the vehicle), is suitable for providing new data about the elements to be used in a method according to the invention, or to update or provide any other information which may be useful to perform such a method.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In this text, the term “comprises” and its derivations (such as “comprising”, etc.) should not be understood in an excluding sense, that is, these terms should not be interpreted as excluding the possibility that what is described and defined may include further elements, steps, etc.

### BRIEF DESCRIPTION OF THE DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1 shows an automotive vehicle which comprises an automotive projection assembly according to the invention.

FIG. 2 shows some steps of a method according to the invention.

FIG. 3 shows an automotive vehicle comprising an alternative automotive projection assembly according to the invention.

### DETAILED DESCRIPTION OF THE INVENTION

Elements of the example embodiments are consistently denoted by the same reference numerals throughout the drawings and detailed description where appropriate:

1 First light projector

2 First camera

3 Second light projector

4 Second camera

5 Person

6 Projector control unit

7 Dashboard

8 Aim projected image

10 Automotive vehicle

11 Dimmed zone of the first light pattern

12 Main zone of the first light pattern

13 Dimmed zone of the second light pattern

14 Main zone of the second light pattern

15 Zone of the dashboard which only receives the main zone

16 Mirror

17 Rotatory element

18 Coupler

19 Housing

20 Hole of the housing

21 Roof

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

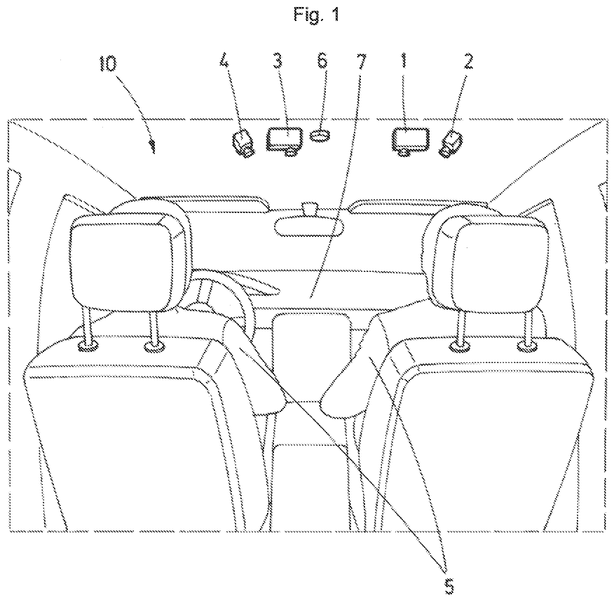

FIG. 1 shows a particular embodiment of an automotive projection assembly according to the invention.

This assembly comprises a first light projector 1, a first camera 2, a second light projector 3, a second camera 4 and a projector control unit 6.

This assembly is located in the interior of an automotive vehicle 10, where two people 5 are sit on the front seats.

The cameras 2, 4 are configured to sense the presence of the two people 5 by means of an edge recognition algorithm, and to send information about their location, size and shape to the projector control unit. The projector control unit 6 then elaborates a protection zone using these data.

This projector control unit 6 is also configured to establish a calibration routine between both light projectors when demanded.

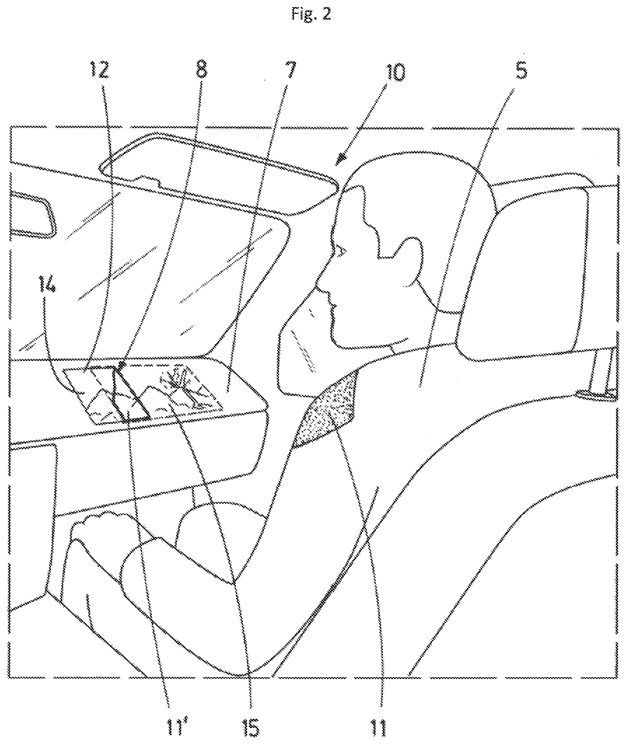

FIG. 2 illustrates some steps of a particular embodiment of a method according to the invention.

The passenger 5 is located between the second projector 2 and a portion of the aim projected image 8, which is intended to be located on the dashboard 7 of the vehicle 10.

Hence, the first light projector 1 projects a first image pattern. This first image pattern has a first dimmed zone 11 which is intended to impinge on the passenger 5 and a main zone 12 which is intended to impinge on the dashboard 7, as a part of the aim projected image 8.

In turn, the second light projector 3 projects a second image pattern. This second image pattern does not have any dimmed zone, since the passenger 5 is not blocking the projection of the second light projector 3. In some embodiments, there would be a second dimmed zone if the passenger was also blocking part of the second image pattern. In this case, the second image pattern has a main zone 14 which is intended to impinge on the dashboard 7 as a part of the aim projected image 8. This main zone 14 of the second image pattern has a portion which impinges on a zone of the dashboard 7 coinciding with the main zone 12 of the first image pattern and has another portion which impinges on a zone 15 of the dashboard 7 where no other image pattern does. This last zone 15 is not reachable by the first image pattern due to the interposition of the obstacle 5.

The luminous intensity of the first and second image patterns is carefully adjusted by the projector control unit 6 to obtain a homogeneous projected image.

The first dimmed zone 11 is completely black, with no luminous intensity, to avoid glaring the passenger 5 and also to save energy, since the light projected on the objects is not useful.

The dimmed and main zones of the light patterns provided by the light projectors may be recalculated according to a predetermined interval, to update the projections when the position of the passenger changes.

In any case, the system is connected by a communication port with the manufacturer server via a communication protocol, such as GPRS, to send and receive updating about new features to be included in the method.

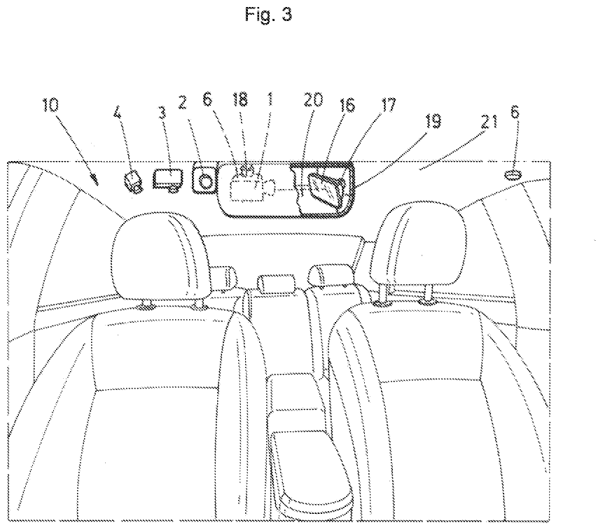

FIG. 3 shows an automotive vehicle 10 comprising an alternative automotive projection assembly according to the invention.

This assembly comprises a housing 19, where the first light projector 1 and a mirror 16 are housed. The first light projector 1 is configured to project a light pattern towards the mirror 16 and the mirror 16 is configured to reflect the light pattern received from the first light projector 1 onto an interior surface of the vehicle 10. The distance between the light projector 1 and the mirror 2 is about 20 cm, to optimise the size of the projected pattern.

The mirror 16 further comprises a rotatory element 17 configured to rotate the mirror 16, to allow the mirror to cover a wider range of the interior surface of the vehicle 10. The mirror 16 is able to reflect the image received by the first projector 1 through a hole 20. This hole 20 is wide enough to allow the reflection of the light through the whole range of rotation of the mirror.

The first light projector 1 further comprises a projector control unit 6 which is configured to perform a positional calibration of the light projector 1 with respect to the mirror 2. To complete this calibration, a camera 8 is also part of the projection assembly.

The light projector 1 is attached to the roof 21 of the vehicle 10 by means of a coupler 18, and the mirror 16 is also attached to the roof 21 of the vehicle 10 by means of the rotatory element 17. The housing 19 is in turn fixed to both elements 17, 18, to achieve a dimensional stability.

In any case, the system is connected by a communication port with the manufacturer server via a communication protocol, such as GPRS, to send and receive updating about new features to be included in the method.

What is claimed is:

1. A method for light projection in the interior of an automotive vehicle, the method comprising:
sensing, by at least one sensor, the presence of an object or person in the interior of the vehicle, wherein the sensor includes a plurality of image sensing devices;
defining a protection zone by using the data of the at least one sensor, thus obtaining a three-dimensional protection zone;
projecting a first light pattern with a first pattern zone by means of a first projector associated to a first image sensing device; and
projecting a second light pattern with a second pattern zone by means of a second projector associated to a second image sensing device,
wherein the first pattern zone or the second pattern zone are projected over the protection zone and combined to form a combined pattern of a projected image on an interior surface of the automotive vehicle.

2. The method according to claim 1, wherein the first and second pattern zones are projected over the protection zone.

3. The method according to claim 1, wherein the first pattern zone has a lower average luminous intensity than the combined pattern.

4. The method according to claim 3, wherein the combined pattern has no luminous intensity in the first pattern zone.

5. The method according to claim 1, wherein sensing the presence of an object and defining the protection zone are carried out more than once during the projection.

6. The method according to claim 1, wherein a portion of the projected image receives only the first light pattern.

7. The method according to claim 1, wherein a portion of the projected image receives a combination of the first light pattern and the second light pattern.

8. An automotive projection assembly comprising:
at least a first image sensing device;
a first light projector associated to the first image sensing device;
a second image sensing device;
a second light projector associated to the second image sensing device; and
a projector control unit configured to:
sense, by at least one sensor, the presence of an object or person in an interior of a vehicle, wherein the sensor includes the first and the second image sensing devices;
define a protection zone by using the data of the at least one sensor, thus obtaining a three-dimensional protection zone;
project a first light pattern with a first pattern zone by means of a first projector; and
project a second light pattern with a second pattern zone by means of a second projector, wherein the first pattern zone or the second pattern zone are projected over the protection zone and combined to form a combined pattern of a projected image on an interior surface of the vehicle.

9. The automotive projection assembly according to claim 8, wherein the projector control unit is further configured to perform a positional calibration of the first light projector with respect to the second light projector.

10. The automotive projection assembly according to claim 1, wherein the first and second light projectors are configured to project a three-dimensional light pattern.

11. The automotive projection assembly according to claim 10, further comprising a mirror, wherein the first or the second light projector is configured to project a light pattern towards the mirror.

12. The automotive projection assembly according to claim 11, wherein the mirror includes a rotatory element configured to rotate the mirror.

13. The automotive projection assembly according to claim 12, wherein the rotatory element includes attaching means for attaching the rotatory element to a roof of an automotive vehicle.

14. The automotive projection assembly according to claim 8, further comprising attaching means for attaching the first and second light projector to a roof of a vehicle.

15. The automotive projection assembly according to claim 12, wherein the rotatory element is configured to provide rotation in two different axis.

16. The automotive projection assembly according to claim 8, further comprising a housing where the light projectors and a mirror are housed.

17. The automotive projection assembly according to claim 16, wherein the distance between the light projectors and the mirror is less than 40 cm.

18. The automotive projection assembly according claim 8, further comprising a communication port, configured to send and/or receive information via a communication protocol, such as WPAN, WLAN, WMAN or WWAN.
